(19) United States
(12) Patent Application Publication
(10) Pub. No.: US 2002/0010957 A1
(43) Pub. Date: Jan. 31, 2002

(54) Apparatus for use in food preparation and method for manufacturing thereof

(76) Inventor: Neal E. Katz, Wheeling, IL (US)

Correspondence Address: Jeffrey A. Pine, BANIAK PINE & GANNON, 150 N. Wacker Drive, Suite 1200, Chicago, IL, 60606, US

(21) Appl. No.: 09/861,100

(22) Filed: May 18, 2001

Related U.S. Application Data
(60) Provisional application No. 60/205,397, filed on May 19, 2000.

(51) Int. Cl. B32B 1/02; A41D 19/00; B65D 1/00; B32B 1/08; B29D 22/00; B29D 23/00

(52) U.S. Cl. 2/161.7; 428/35.2

(57) ABSTRACT

A glove to be used during food preparation procedures, configured such that the digital portion, the thumb and at least one finger, is separated out from the palmar portion of the glove, which also contains an edge thereon simulating the function of a spatula. The configuration allows full use of the thumb and at least the index finger, along with the edge portion, facilitating the food preparation process while obtaining the health benefits associated with a glove.

### TECHNICAL FIELD

The present invention relates to a novel glove apparatus for use in food preparation and the manufacture of the glove, and more specifically, the present invention relates to a novel glove containing a digital portion, a palmar portion and an edge portion. The edge portion of the novel glove apparatus is located on the glove apparatus and is configured to emulate the functions of a spatula or a spoon, i.e., to facilitate scooping of food materials.

### BACKGROUND OF THE INVENTION

In order to simplify the food preparation process, especially the function of mixing of ingredients, it is easier for the person preparing the food to use his or her hands instead of a spoon or other utensil. However, although using ones hands may facilitate the food preparation process, it also increases the chance of contamination when germs and bacteria, that may not have been properly cleaned off of the hands, are transferred to the food. Those germs and bacteria, when ingested, may cause sickness or, in some cases, even death.

In order to reduce the chance of contamination, people who prepare food wear gloves. Gloves for use in food preparation have been in existence for many years. In general, gloves allow the person preparing the food to handle the food without actually touching it, thereby decreasing the chance of the food becoming contaminated from the person preparing the food. Since the use of gloves has become more commonplace, the percentage of individuals becoming sick due to this type of contamination has decreased.

In many places, laws and regulations have been enacted that require anyone preparing food items to wear a glove or gloves during the food preparation. Thus, gloves have become a necessary item used during food preparation.

Another item that is utilized to facilitate certain procedures in the food preparation industry is the spatula. A spatula is usually made of a hardened plastic or rubber that is somewhat pliable, and is usually attached to a handle or stick. The handle is usually made of wood or metal. Because the plastic or rubber portion of the spatula can bend, the spatula forms to the container and makes more contact with the container then, for example, a spoon. It is thus easier to mix ingredients using a spatula then a spoon.

In many instances, mixing ingredients during food preparation occurs in a bowl or some other container. A person preparing the food will use a spatula to more thoroughly mix or scoop the food items or ingredients in that bowl or container. For example, it is easier to mix eggs and flour in a bowl using a spatula then it is to mix the same mixture using a spoon. Further, it is easier to scoop the entire mixture out of the bowl once the mixing has been completed.

However, when a person preparing food wears gloves and uses a spatula, the food preparation time is increased. This is because there are many instances during the food preparation when it is necessary to use a spatula and many times when it is necessary to use one's hands. Thus, the person preparing the food is continually picking up and putting down the spatula. Although the time for each of these actions is minimal, when a person preparing food does this hundreds or thousands of times each day the total time accumulates.

U.S. Pat. No. 5,294,467, issued to Hoodes, describes a hand held utensil that contains a blade with an arcuate working edge and radially spaced concave and convex surfaces, in an attempt to create an ergonomically designed grip. The principle behind the Hoodes designed utensil is to allow the user to apply a greater force than can be applied for instance, by a standard ice cream scoop. Hoodes does not address the inefficiency problems inherent with using gloves and a spatula-type device.

U.S. Pat. No. 5,169,191, issued to Benz, describes a pair of hand held scoops which are provided for gathering loose materials such as leaves, grass cuttings, etc. The Benz device attaches to the hand but does not indicate contamination concerns since the scoops were not intended to be used with food product.

U.S. Design Patent No. Des. 258,625, issued to Sheridan, discloses a heat-protective arm and hand glove for hot food service. The Sheridan glove is intended for hot food service and does not describe nor show an attached edge portion for preparation of hot and cold food.

Although there are many gloves and spatulas for use in the food preparation industry in the prior art, none possess all of the advantages of the present invention.

### SUMMARY OF THE INVENTION

The present invention combines the safety and health benefits associated with utilizing a glove or gloves during the preparation of food items, along with the functional benefits of using a spatula during said food preparation. The present invention greatly simplifies and decreases the time for preparing certain food items, especially the mixing of ingredients and the scooping of food items out of a bowl or container.

The present invention is a modified glove to be used during food preparation procedures. The glove is configured such that the thumb and at least one finger are separated out from the “mitten” or palmar portion of the glove. This area of the glove, containing the thumb and at least one finger is the finger or digital portion. This configuration allows the person preparing the food items to have full use of his or her thumb and at least the index finger. Having the use of these two digits makes food preparation easier than if the glove was configured similar to a mitten.

The glove of the present invention is also modified such that the remaining fingers, usually the remaining three fingers referred to as the middle finger, the ring finger and the pinkie, are all placed into the mitten or palmar portion of the glove. Using two or three fingers for the palmar portion of the glove increases the scooping ability of the person preparing the food items. Although two or three fingers are contemplated herein, one finger, the pinkie, can be used in the present invention and still effect the functions of the invention.

Further, a material that is usually harder than the rest of the glove material, is located at the bottom of the palmar portion, near the pinkie, running approximately parallel to the pinkie. This material is configured to act as an edge or spatula at the end of the glove. By placing a spatula onto the modified glove, the person preparing the food item can utilize the spatula on the glove for mixing and scooping without the constant need to put down or pick up a separate spatula.

As described above, the finger or digit portion can contain the thumb and at least one finger. The palmar portion can contain the remaining fingers. And the spatula or edge portion is located at the bottom or the pinkie area of the glove. The person preparing the food can have the same or similar safety and health benefits of a glove, along with the same or similar benefits of the spatula function, all in one.

### BRIEF DESCRIPTION OF THE DRAWINGS

FIG. 1 is a front view of a glove apparatus for use in food preparation embodying the present invention;

FIG. 2 is a side view of a glove apparatus for use in food preparation embodying the present invention;

FIG. 3 is a view of a glove apparatus for use in food preparation embodying the present invention as the invention is used to mix or scoop food items;

FIG. 4 is a side view of a glove apparatus for use in food preparation embodying the present invention;

FIG. 5 is a front view of a glove apparatus for use in food preparation embodying the present invention.

### DETAILED DESCRIPTION OF THE INVENTION

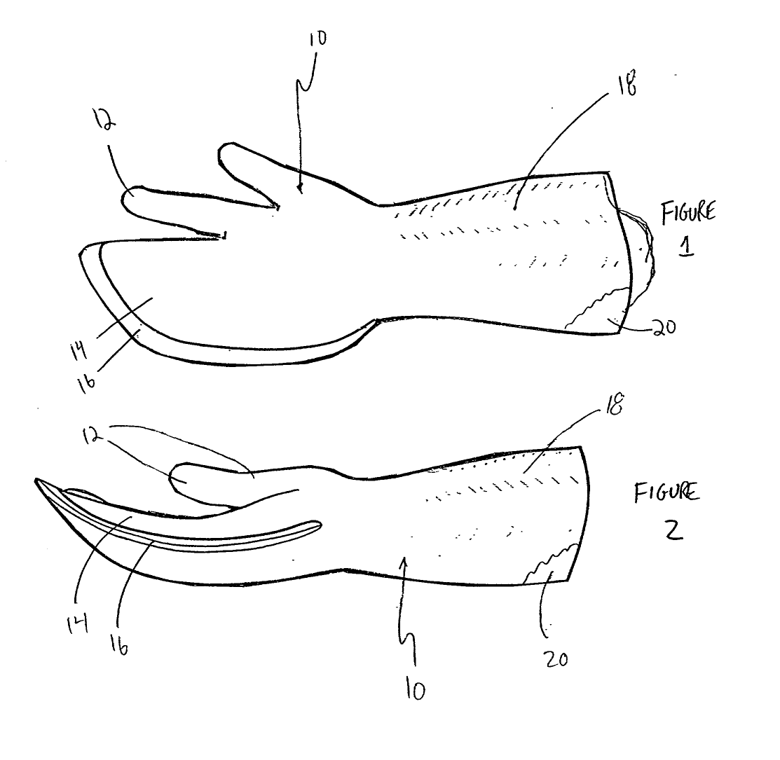

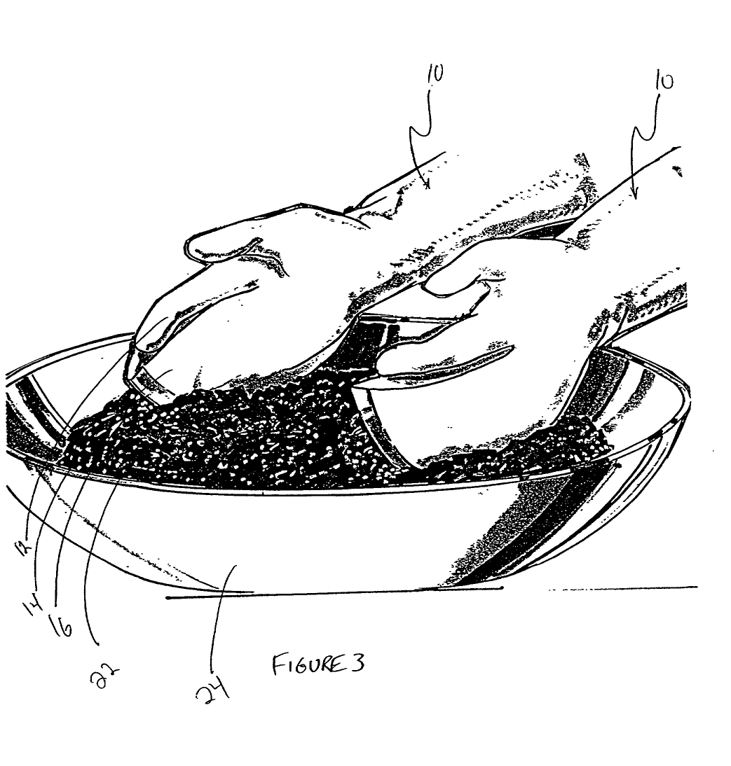

FIGS. 1 and 2 show the front view of a glove apparatus 10 for use in the food preparation industry. The glove can be manufactured using many different materials, such as a polyvinyl elastomer, thermoplastic elastomer, a natural rubber, or silicone. Each of these materials has been approved by the National Safety Foundation (NSF). Each has certain advantages over the other materials, for instance, silicone can be used in situations where heat up to 500 degrees (or higher) is to be used, such as the preparation of sauces and the like. However, other materials, which are known in the art, may be used in the manufacturing process of the present invention.

The glove 10 contains a finger or digital portion 12, a palmar portion 14, and a spatula or edge portion 16. The glove 10 is the approximate size of a standard glove that is intended to cover the human hand. Since human hands are different sizes, the glove may be manufactured in different sizes. The gloves can also be color coded such that the size will be known by merely looking at the glove 10.

The glove 10 may also contain a wrist portion 18. Depending on the usage of the glove 10, a wrist portion 18 may be manufactured at the time that the rest of the glove 10 is manufactured. The wrist portion 18 would act to protect the wrist, and some of the arm above the wrist, from making contact with the food item.

When the glove 10 is manufactured, the digital portion 12, palmar portion 14, and if used, the wrist portion 18, should form a seamless construction as found on many gloves used in the food industry. However, depending on the manufacturing method, certain portions of the glove 10 may be manufactured at different times, and in some cases there may be seems located on the gloves. Further, to the extent that different materials are used for different portions of the glove 10, there may be a seem where the different materials meet. These seems do not affect the overall function of the glove 10 of the present invention.

The finger or digital portion 12 of the glove 10 is manufactured such that the thumb, and at least one other finger can be placed into the digital portion 12. In the preferred embodiment, the digital portion 12 is manufactured and configured to accept the thumb and the index finger of the human hand. This configuration allows the person wearing the glove to be able to use the thumb in conjunction with the index finger to access food items and utensils. In configurations where the index finger is not available, such as a mitten type arrangement, it can be difficult for the person wearing the glove to pick up food items or utensils.

The palmar portion 14 of the glove 10 is manufactured and configured such that any fingers not inserted into the digital portion 12 are inserted into the palmar portion 14. It is easy to understand that, since there is no where else for the fingers to be placed besides the digital portion 12 or the palmar portion 14, depending on how many fingers (along with the thumb) are placed into the digital portion 12, the remaining fingers will be inserted into the palmar portion 14.

The glove apparatus 10 may contain an insert or lining 20 (shown in cutaway in FIG. 1), which is either manufactured inside the digital portion 12 and the palmar portion 14, or assembled after the digital portion 12 and palmar portion 14 are manufactured. In either event, the insert 20 acts to insulate or protect the person wearing the glove 10 from the food items that the glove 10 comes in contact with. The insert 20 also increases the safety of the wearer and makes the glove 10 more comfortable to wear.

The insert or liner 20 is manufactured from a textile, such as fabric, cotton, nylon, polyester or a textile flock. One having ordinary skill in the art would be able to find other materials that could be used as the insert or lining 20 with the same resulting benefits. In most instances, the insert 20 should be made from materials that are fire resistant or retardant.

The spatula or edge portion 16 of the glove 10 is attached to the bottom of the palmar portion 14, near the area where the pinkie finger would normally be found. The length of the edge portion 16 can vary depending on the intended use and the size of the user's hand, preferably the edge portion 16 will run from the wrist portion 18, along the bottom of the palmar portion 14, and curve up along where the palmar portion covers the other fingers. Shorter and longer edge portions 16 are contemplated. The edge portion 16, which is located on the outside of the palmar portion 14, can be curved to enhance the mixing and scooping capabilities inherent therein. It can be understood that the edge portion 16 is configured to approximate the edge of a spatula. This configuration allows the person wearing the glove 10 to use the edge portion 16 as a spatula when mixing or scooping is to be accomplished.

The edge portion 16 is manufactured from material that is usually more rigid than the material used for the digital portion 12 and the palmar portion 14. Such materials used in the manufacturing process of the edge or spatula portion 16 include silicone, expanded plastic foam or white neoprene, although other materials as described above are contemplated. Alternatively, a metal edge portion 16 can be utilized for food preparation or for other applications.

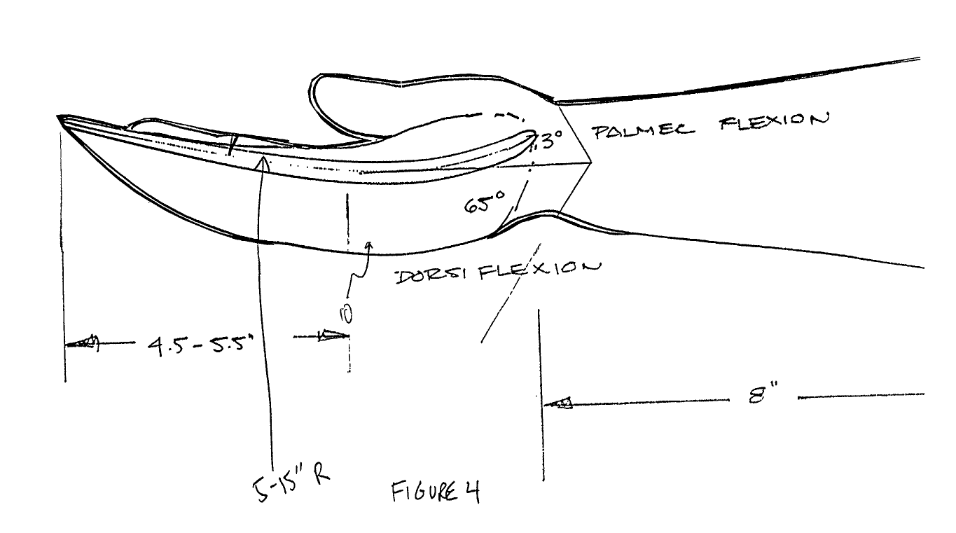

FIG. 3 shows the gloves 10 of the present invention as used in the food industry. The gloves 10 contain the digital portion 12, palmar portion 14, and an edge portion 16. When a food item 22 is placed in a bowl 24, the person wearing the gloves 10 will have an easier time picking up the food item 22 by using the edge portion 16 of the glove 10. The edge portion 16 will make more contact with the bowl 24 than a standard glove (not shown), or a hand without a glove.

The glove 10 acts as a spatula or scraper would work in conjunction with a bowl 24, while allowing the user to pick up utensils and other food products using the digital portion 12 of the glove 10. Meanwhile, the user is wearing a glove 10 thereby reducing the risk of contamination to the food item 22, as described above.

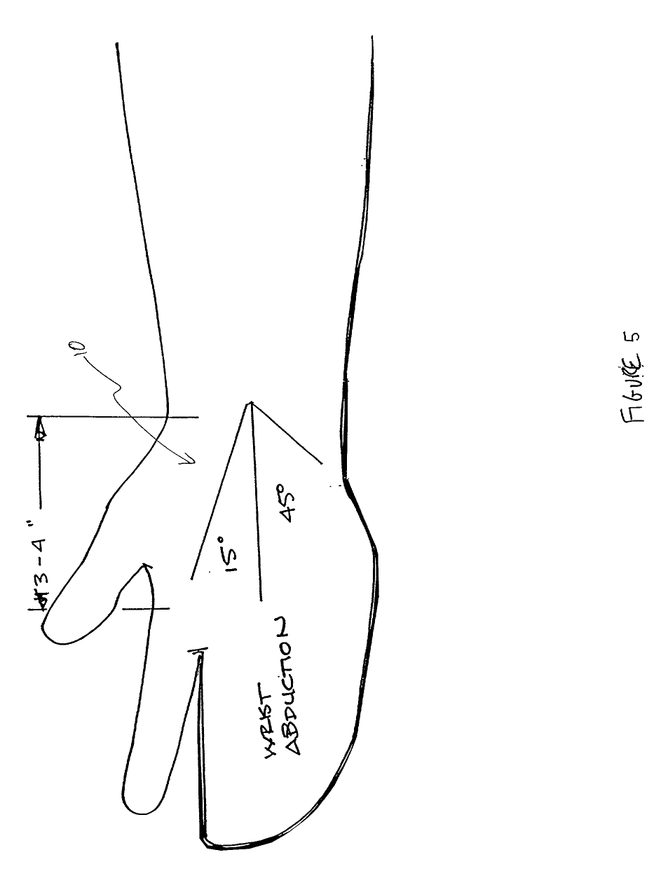

FIG. 4 shows a side view of the glove 10, and includes some preferred dimensions of the glove 10, including preferred radii and degrees, pertaining to the edge portion 16 and the flexibility pf the glove 10. The wrist portion 18 is preferably 8″, to protect the wrist of the user. Other dimensions can be incorporated with similar results.

FIG. 5 shows the glove 10 of the present invention from a front view along with certain preferred dimensions including various angles. Again, those angles pertain to the flexibility of the glove, and can be varied and still obtain the benefits of the invention described herein.

There are many different ways to manufacture the glove 10 of the present invention. These methods include one-step processes such as rotational molding, injection molding utilizing an injection press and blow molding. One having ordinary skill in the art would understand how to apply these processes to manufacture the present invention.

Under the preferred method of manufacturing the glove 10 of the present invention, a nylon glove liner (if used) is placed over a mold core. The mold core may be the shape of a human hand, thus each finger of the glove will fit over a mold finger on the mold core. As described above, the liner can be a myriad of materials including cotton, nylon or textile flock. The liner serves many purposes. Initially, the liner facilitates the efficiency of the manufacturing process by allowing the simplified removal of the molded glove from the mold core after the initial molding process. The liner also acts as a protective coating between the hand and the glove material itself, such as silicone, etc. The liner adds to the user's comfort level while providing additional protection for the user's hand. Of course, the use of a liner is not necessary to the present invention and thus can be eliminated from the manufacturing process.

Once placed on the mold core, an injection press is cycled to close the mold with the glove on the core. The injection press then injects silicone rubber (or one of the other materials as described above) into the mold area covering the glove liner outer surface taking on the shape of the mold, which as described above is the shape of the human hand with a spatula edge. The press is then opened and the finished glove containing the liner and the finished molded silicone rubber is removed from the mold core and cured.

In a two-step molding process where a second color is intended for the spatula edge, once the molded glove is cured, the glove is placed onto a second mold core. The injection press is closed and the colored silicone is injected into the press such that the colored silicone will adhere to the molded glove only in certain designated areas. The preferred area to be color-coded is the edge portion of the molded glove. The color-coding can be for a multitude of reasons, however, in the preferred embodiment, the edge portion is color coded to indicate the different sizes of the particular gloves. For example, a blue edge portion may indicate a large-size glove, while a red edge portion may indicate a small-size glove and a green edge portion may indicate a medium-size glove. Of course there are many colors that can be used for the edge portion, and the entire glove can be color coded such that only a one-step manufacturing process need be used to obtain the same results.

It can be seen that the present invention provides a glove for use in food preparation, which is capable providing the health, and safety benefits of a glove, along with the functional benefits of a spatula. Various changes may be made in the function and arrangement of parts: equivalent means may be substituted for those illustrated and described; and certain features may be used independently from others without departing from the spirit and scope of the invention as defined in the following claims.

1. A glove apparatus to be worn during food preparation comprising:
a) a digital portion, said digital portion containing at least one digital receptacle, said digital receptacle being hollow and capable of receiving a thumb of a human hand;
b) a palmar portion, said palmar portion containing a single palm receptacle, said palm receptacle being hollow and being capable of receiving a palm of said human hand and up to four fingers from said human hand, said palmar portion comprising an inner portion and an outer portion, said outer portion comprising a first end and a second end, said first end located adjacent to said digital portion, and said second end located at the opposite end of said palmar portion away from said digital portion, said palmar portion comprising an edge portion at said second end.

2. The glove apparatus as claimed in claim 1, wherein said digital portion comprises two digital receptacles, said two digital receptacles being hollow and capable of receiving said thumb and a forefinger on said human hand.

3. The glove apparatus as claimed in claim 1, wherein said digital portion comprises three digital receptacles, said three digital receptacles being hollow and capable of receiving said thumb, said forefinger, and a middle finger on said human hand.

4. The glove apparatus as claimed in claim 2, wherein said palmar portion comprises a palm receptacle being hollow and capable of receiving said palm of said human hand and three fingers of said human hand, said three fingers of said human hand not including said thumb or said forefinger of said human hand.

5. The glove apparatus as claimed in claim 3, wherein said palmar portion comprises a palm receptacle being hollow and capable of receiving said palm of said human hand and two fingers of said human hand, said two fingers of said human hand do not include said thumb, said forefinger, or said middle finger of said human hand.

6. The glove apparatus as claimed in claim 1, wherein said digital portion comprises a material selected from the group consisting of polyvinyl elastomer, thermoplastic elastomer, natural rubber, and silicone.

7. The glove apparatus as claimed in claim 1, wherein said palmar portion comprises a material selected from the group consisting of polyvinyl elastomer, thermoplastic elastomer, natural rubber, and silicone.

8. The glove apparatus as claimed in claim 7, wherein said palmar portion comprises a material that is the same as the material used for said digital portion.

9. The glove apparatus as claimed in claim 7, wherein said palmar portion comprises a material that is different from the material used for said digital portion.

10. The glove apparatus as claimed in claim 1, wherein said edge portion is curved to enhance said food preparation feature.

11. The glove apparatus as claimed in claim 10, wherein said edge portion comprises a material more rigid than the material used for the digital portion.

12. The glove apparatus as claimed in claim 1, further comprising a lining located inside the digital and palmar portions.

13. The glove apparatus as claimed in claim 12, wherein said lining comprises a textile insert.

14. The glove apparatus as claimed in claim 1, further comprising a wrist portion.

15. The glove apparatus as claimed in claim 14, wherein said wrist portion covers a wrist and forearm portion of a human arm.

16. The glove apparatus as claimed in claim 15, wherein said wrist portion comprises a material selected from the group consisting of polyvinyl elastomer, thermoplastic elastomer, natural rubber, and silicone.

17. A method of manufacturing a glove apparatus to be worn during food preparation, said glove apparatus containing a first and second portion, said first portion being either a digital portion or a palmar portion, and said second portion being the remaining portion, comprising the steps of:
a) Providing a ceramic mold containing the negative impression of said first portion of said glove apparatus;
b) Dipping said ceramic mold into a slurry of material, and then removing said ceramic mold from said slurry and allowing to cure;
c) Removing said cured material from said mold;
d) Placing said cured material onto a second mold in order to form a second portion;
e) Adhering said second portion onto said first portion.

18. A method of manufacturing a glove apparatus to be worn during food preparation, said glove apparatus containing a first and second portion, said first portion being either a digital portion or a palmar portion, and said second portion being the remaining portion, comprising the steps of manufacturing a glove apparatus in a one-step process from the group consisting of rotational molding, injection molding, and blow molding.
